(19) United States
(12) Patent Application Publication
(10) Pub. No.: US 2009/0200942 A1
(43) Pub. Date: Aug. 13, 2009

(54) Plasma display panel and plasma display apparatus

(76) Inventors: Takashi Sasaki, Kunitomi (JP); Yuka Kobayashi, Kunitomi (JP)

Correspondence Address: MCDERMOTT WILL & EMERY LLP, 600 13TH STREET, N.W., WASHINGTON, DC, 20005-3096, US

(21) Appl. No.: 11/920,833

(22) PCT Filed: Jul. 26, 2005
(86) PCT No.: PCT/JP2005/013613

§ 371 Date: Jan. 16, 2009

(51) Int. Cl. H01J 17/49

(52) U.S. Cl. 313/586

(57) ABSTRACT

A plasma display panel capable of reducing further a surface discharge voltage without additionally providing a process leading to cost increase, and contributing to the reduction in address discharge delay. The plasma display panel comprises an electrode group of an X electrode and a Y electrode consisting of adjacent transparent electrodes disposed in parallel to a front plate and forming gaps discharging at a specified gap and bus electrodes thicker than the transparent electrodes, lower in electric resistance, and electrically connected to the transparent electrodes, a dielectric layer and a protective layer covering the electrode group of the X electrode and the Y electrode, and an electrode group of address electrodes disposed on a rear plate disposed facing the front plate and in a direction perpendicular to the electrode group of the X electrode and the Y electrode, wherein the bus electrodes (16) are disposed continuously from the one end to the vicinity of the other end of the front plate (1) and away from the discharge edge of the transparent electrode (15), and the discharging edge of the transparent electrode (15) is provided with a separation bus (17) thicker than the transparent electrode (15) so as to let the dielectric layer (13) on the front plate (1) have a surface shape reflecting unevenness resulting from the thicknesses of the bus electrode (16) and the separation bus (17) on the front plate (1), whereby it is possible to form a recessed portion (18) resulting from the separation bus (17) in a gap portion.

### TECHNICAL FIELD

The present invention relates to a plasma display apparatus. In particular, it relates to a technology effectively applied to a structure of a plasma display panel provided in the plasma display apparatus.

### BACKGROUND ART

For example, a plasma display panel provided in a plasma display apparatus is constituted of a front plate made of glass and a rear plate similarly made of glass. In the front plate, X electrodes and Y electrodes are alternately disposed in parallel to each other, the electrode group thereof is covered with a dielectric layer, and a surface of the dielectric layer is covered with a protective film. In the rear plate, address electrodes are disposed in a direction almost perpendicular to that of the electrode group of the X electrodes and the Y electrodes and the address electrodes are covered with a dielectric layer. Barrier ribs are disposed on both sides of the address electrode, and the barrier ribs partition the cells in a column direction. Further, phosphors are applied on the sidewalls of the barrier ribs and between the barrier ribs. The front plate and the rear plate are bonded so that the protective layer makes contact with the barrier ribs, and the discharge gas is filled in the spaces therebetween. In this manner, the plasma display panel is manufactured.

In the plasma display panel having the structure as described above, the vapor deposition method has attracted attention as a method for forming a dielectric layer in recent years. The dielectric layer obtained by the vapor deposition method is characterized in that its surface can be formed to have an uneven shape reflecting the uneven shape of an underlying surface. By using the vapor deposition method, a dielectric layer of a plasma display panel is formed to have an uneven surface in which a part above an electrode protrudes relative to other parts by the thickness of the electrode. On the other hand, the technology in which a trench is formed in a gap portion and the discharge is started at an opposed electrode instead of a surface electrode in order to reduce the firing voltage has been proposed. For example, Patent Document 1 discloses the technology of forming a recessed portion in a gap portion of a dielectric layer. Further, Patent Document 2 discloses the technology of forming a protruding portion on a part of a dielectric layer above an electrode.

Patent Document 1: Japanese Patent Application Laid-Open Publication No. 11-297209

Patent Document 2: Japanese Patent Application Laid-Open Publication No. 2000-188063

### DISCLOSURE OF THE INVENTION

### Problem to be Solved by the Invention

However, in the plasma display apparatus as described above, if a recessed portion is to be formed in a part of a dielectric layer as described in the technology of Patent Document 1, the addition of some processes is inevitable and the cost is adversely increased. Further, even when a protruding portion of a dielectric layer is formed at a position apart from a gap as described in Patent Document 2, the sufficient effect cannot be achieved.

Therefore, an object of the present invention is to provide a plasma display panel capable of reducing surface discharge voltage and contributing to the reduction of the address discharge delay without additionally providing new process which leads to cost increase and a plasma display apparatus including the plasma display panel.

The above and other objects and novel characteristics of the present invention will be apparent from the description of this specification and the accompanying drawings.

### Means for Solving the Problems

The typical ones of the inventions disclosed in this application will be briefly described as follows.

For example, the present invention is applied to a plasma display panel comprising: a first substrate in which a first electrode group including a plurality of optically-transparent electrodes and a plurality of metal electrodes having lower electric resistance than the optically-transparent electrode and electrically connected to the optically-transparent electrode, a dielectric layer covering the first electrode group, and a protective layer covering the dielectric layer are disposed and discharging spaces are formed between the adjacent optically-transparent electrodes; and a second substrate arranged so as to be opposed to the first substrate and having a second electrode group disposed in a direction almost perpendicular to the first electrode group or to a plasma display apparatus having the plasma display panel and a drive circuit for applying voltage to electrodes of the plasma display panel, wherein a conductive layer is formed adjacent to the discharging space on the optically-transparent electrode, and the dielectric layer of the first substrate has a surface shape reflecting unevenness resulting from a thickness of the first electrode group and the conductive layer.

Further, at least one of the following characteristics is provided.

(1) The conductive layer has a width smaller than the metal electrode.

(2) The conductive layer has a thickness of 2 μm or more and is formed to be thinner than the dielectric layer.

(3) The conductive layer is made of the same material as that of the metal electrode and is formed to have the same height as that of the metal electrode.

(4) The dielectric layer has a thickness of 10 μm or less and is formed to be thicker than the conductive layer.

(5) The dielectric layer is formed by a vapor deposition method.

(6) The conductive layer is formed to be separated for each cell.

### Effect of the Invention

The effects obtained by typical aspects of the present invention will be briefly described below.

According to the present invention, since the electric field can be effectively used by forming a dielectric layer between electrodes for performing discharge into a recessed shape, it is possible to further reduce the surface discharge voltage and also possible to contribute to the reduction of the address discharge delay.

Further, according to the present invention, the plasma display panel having the structure as described above can be manufactured without additionally providing new process which leads to cost increase.

### BRIEF DESCRIPTION OF THE DRAWINGS

FIG. 1 is an exploded perspective view showing an example of a structure of a plasma display panel in a plasma display apparatus according to an embodiment of the present invention;

FIG. 2 is a configuration diagram showing an example of a module configuration in the plasma display apparatus according to the embodiment of the present invention;

FIG. 3 is a plan view showing an example of a planar structure of a principal part of a front plate in the plasma display apparatus according to the embodiment of the present invention;

FIG. 4 is a cross-sectional view showing an example of a cross-sectional structure of a principal part of the front plate (section taken along the line a-a′ in FIG. 3) in the plasma display apparatus according to the embodiment of the present invention;

FIG. 5 is a plan view showing another example of a planar structure of a principal part of a front plate in the plasma display apparatus according to the embodiment of the present invention; and

FIG. 6 is a cross-sectional view showing another example of a cross-sectional structure of a principal part of the front plate (section taken along the line b-b′ in FIG. 5) in the plasma display apparatus according to the embodiment of the present invention.

### BEST MODE FOR CARRYING OUT THE INVENTION

Hereinafter, embodiments of the present invention will be described in detail with reference to the accompanying drawings. Note that components having the same function are denoted by the same reference symbols throughout the drawings for describing the embodiment, and the repetitive description thereof will be omitted.

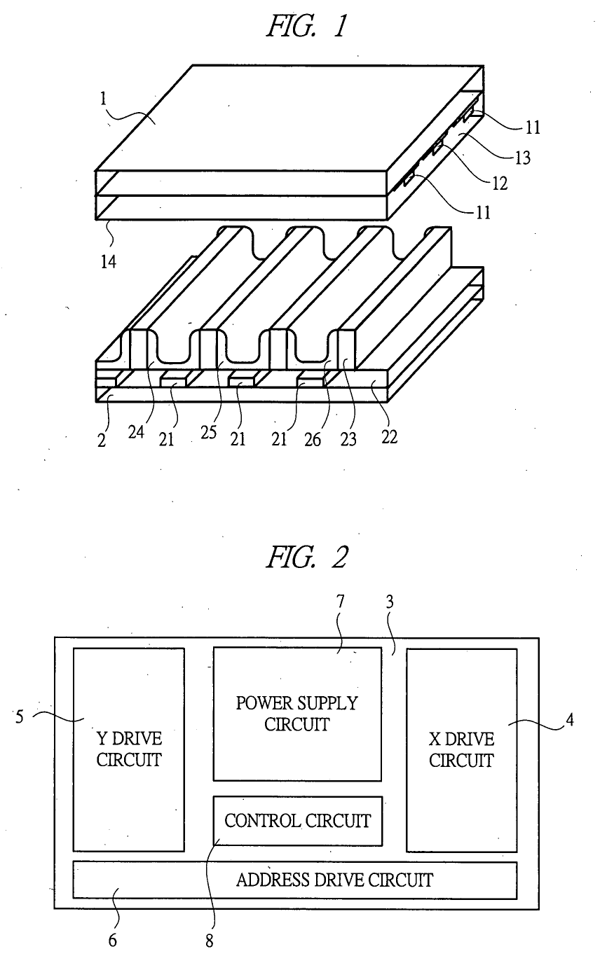

First, an example of the structure of a plasma display panel in a plasma display apparatus according to an embodiment of the present invention will be described with reference to FIG. 1. FIG. 1 is an exploded perspective view showing an example of the structure of a plasma display panel.

The plasma display panel according to the present embodiment is constituted of a front plate 1 which is a first substrate made of glass and a rear plate 2 which is a second substrate similarly made of glass.

In the front plate 1, X electrodes 11 and Y electrodes 12 which repeatedly perform discharges are alternately disposed in parallel to each other. In the front plate 1, an electrode group including the X electrodes 11 and the Y electrodes 12 is covered with a dielectric layer 13, and a surface thereof is further covered with a protective film 14 made of magnesium oxide (MgO) or the like.

In the rear plate 2, address electrodes 21 are disposed in a direction almost perpendicular to that of the electrode group of the X electrodes 11 and the Y electrodes 12 and the address electrodes 21 are covered with a dielectric layer 22. Barrier ribs 23 are disposed on both sides of the address electrode 21 and the barrier ribs 23 partition the cells in a column direction. Further, phosphors 24, 25 and 26 which are excited by ultraviolet to emit visible lights of red (R), green (G) and blue (B) are applied on the dielectric layer 22 above the address electrode 21 and on the sidewalls of the barrier ribs 23.

The front plate 1 and the rear plate 2 are bonded so that the protective layer 14 makes contact with the barrier ribs 23, and discharge gas such as neon (Ne) and xenon (Xe) is filled in the spaces therebetween. In this manner, the plasma display panel is manufactured.

Next, an example of a configuration of a module in the plasma display apparatus according to the present embodiment will be described with reference to FIG. 2. FIG. 2 is a configuration diagram showing an example of a module configuration.

The module is formed on a metal plate 3 provided on a rear surface of the rear plate 2 of the plasma display panel. On this metal plate 3, an X drive circuit 4 which applies voltage to the X electrodes 11 of the plasma display panel, a Y drive circuit 5 which applies voltage to the Y electrodes 12 of the plasma display panel, an address drive circuit 6 which applies voltage to the address electrodes 21 of the plasma display panel, a power supply circuit 7 for the respective drive circuits, and a control circuit 8 which controls these circuits are provided.

In the plasma display apparatus including the plasma display panel and the module configured as described above, the X electrode 11 and the Y electrode 12 mainly perform the sustain discharges for display light emission. The sustain discharges are performed by repeatedly applying voltage pulses between the X electrode 11 and the Y electrode 12. Further, the Y electrode 12 functions as a scan electrode used when writing display data. On the other hand, the voltage that performs the write discharge for selecting discharge cells between the Y electrode 12 and the address electrode 21 is applied to the address electrode 21.

The discharge of the plasma display panel can take only binary states of ON and OFF. Therefore, the brightness intensity, that is, the grayscale is expressed by the number of times of light emission. Accordingly, a frame is divided into a plurality of sub-fields. Each of the sub-fields includes a reset period, an address period, and a sustain discharge period (sustain period). In the reset period, regardless of the lighting state in the previous sub-field, the operation for setting all the discharge cells to an initial state, for example, to a state where the charge of the barrier rib 23 is erased is performed. In the address period, selective discharges (address discharge) are performed in order to determine the state of ON and OFF of the discharge cell based on the display data, and the wall charge for setting the discharge cell to an ON state is selectively formed. In the sustain discharge period, the discharge is repeated in the discharge cell in which charge of the barrier rib 23 is formed by the address discharge, and a predetermined light is emitted. The driving as described above is controlled by the X drive circuit 4, the Y drive circuit 5 and the address drive circuit 6 through the control circuit 8.

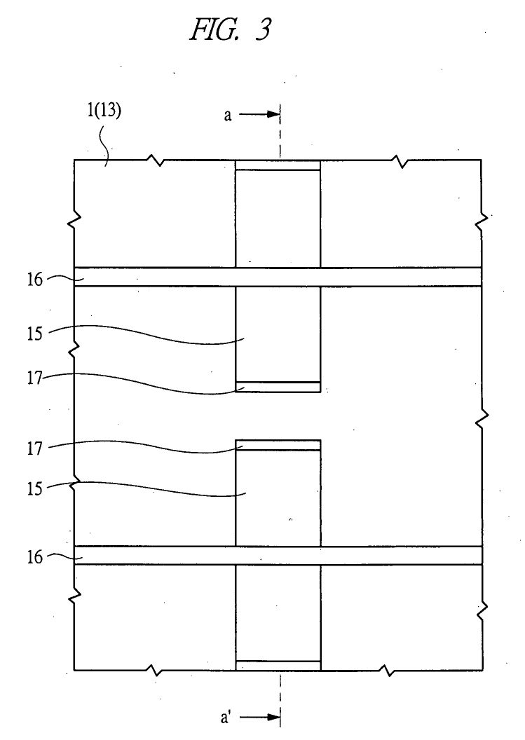

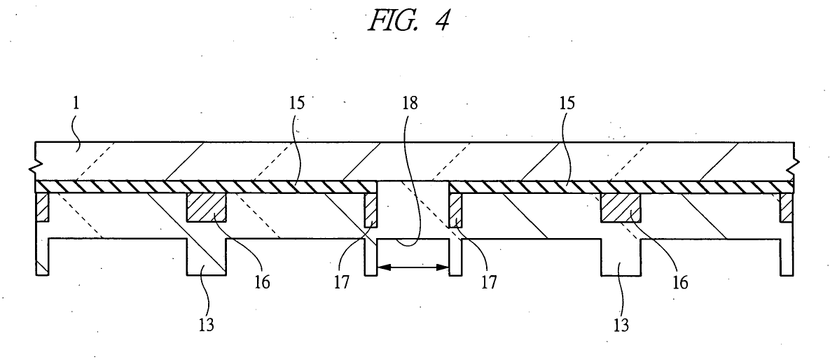

Next, an example of a planar structure and a cross-sectional structure of a principal part of a front plate will be described with reference to FIG. 3 and FIG. 4. FIG. 3 is a plan view showing an example of the planar structure of the principal part of the front plate and FIG. 4 is a cross-sectional view showing an example of the cross-sectional structure of the principal part of the front plate (section taken along the line a-a′ in FIG. 3), respectively.

In the principal part of the front plate 1, the X electrode 11 and the Y electrode 12 are constituted of a transparent electrode 15 which is an optically transparent electrode, a bus electrode 16 which is a metal electrode, a separation bus 17 formed of a conductive layer, a dielectric layer 13 and others. For example, in FIG. 3, an upper part corresponds to the X electrode 11 and a lower part corresponds to the Y electrode 12.

The transparent electrodes 15 are disposed on the front plate 1 and adjacently arranged at predetermined intervals while forming spaces for discharge therebetween (longitudinal direction of FIG. 3).

The bus electrode 16 is thicker than the transparent electrode 15, has lower electric resistance and is electrically connected to the transparent electrode 15. The bus electrode 16 continuously extends from one end of the front plate 1 to near the other end (lateral direction of FIG. 3) and is disposed at the position away from the discharging edge of the transparent electrode 15.

The separation bus 17 is provided at the discharging edge of the transparent electrode 15 so as to be thicker than the transparent electrode 15. The separation bus 17 is formed to have a width smaller than that of the bus electrode 16 (longitudinal direction of FIG. 3). Also, the separation bus 17 is formed to have a thickness of 2 μm or more and to be thinner than the dielectric layer 13, and it is made of the same material as that of the bus electrode 16 and is formed to have the same height as the bus electrode 16 through the same process. Further, the separation bus 17 is formed separately for each cell. Different from the bus electrode 16, the separation bus 17 does not have a function to supply current from an end of a panel to near the other end. Therefore, it does not matter if the separation bus 17 has high electric resistance, and the width thereof can be reduced. On the other hand, since the separation bus 17 is located near the center of the cell, it shields the light emission from the phosphors. Therefore, it is preferable that the separation bus 17 has a width as small as possible.

The dielectric layer 13 has a thickness of 10 μm or less and is formed to be thicker than the separation bus 17. Also, the dielectric layer 13 is formed by a vapor deposition method. The dielectric layer 13 obtained by the vapor deposition method is characterized in that its surface can be formed to have an uneven shape reflecting the uneven shape of an underlying surface. By using the vapor deposition method, the dielectric layer 13 is formed to be protruded in the parts above the bus electrode 16 and the separation bus 17 and recessed in the other parts.

In this manner, the dielectric layer 13 in the part of the X electrode 11 and the Y electrode 12 of the front plate 1 has a surface shape reflecting the unevenness resulting from the thickness of the bus electrode 16 and the separation bus 17 on the front plate 1. In particular, a recessed portion 18 resulting from the thickness of the separation bus 17 can be formed in the gap portion.

For example, the transparent electrode 15, the bus electrode 16, the separation bus 17 and the dielectric layer 13 constituting the front plate 1 are made of the following materials and formed with the dimensions as follows, though not limited thereto. The transparent electrode 15 is made of a material such as indium tin oxide (ITO) and is formed to have a thickness of about 200 nm. The bus electrode 16 is made from a three-layered film of chromium (Cr)/copper (Cu)/chromium (Cr) and is formed to have a width of about 100 μm and a thickness of about 3 μm. The separation bus 17 is made from a three-layered film of Cr/Cu/Cr and is formed to have a width of about 20 μm and a thickness of about 3 μm. The dielectric layer 13 is made of a material such as silicon oxide (SiO₂) and is formed to have a thickness of about 10 μm.

The front plate 1 as described above is manufactured through the following process, though not limited thereto. First, in the process of forming the transparent electrode 15, patterns are formed on a glass substrate by ITO sputtering. Then, in the process of forming the bus electrode 16 and the separation bus 17, patters are formed by the sputtering of the three-layered film of Cr/Cu/Cr. Subsequently, in the process of forming the dielectric layer 13, a film of SiO₂ is formed by the vapor deposition method. Finally, in the process of forming the protective film 14, an MgO film is deposited. Through the processes described above, the front plate 1 is completed.

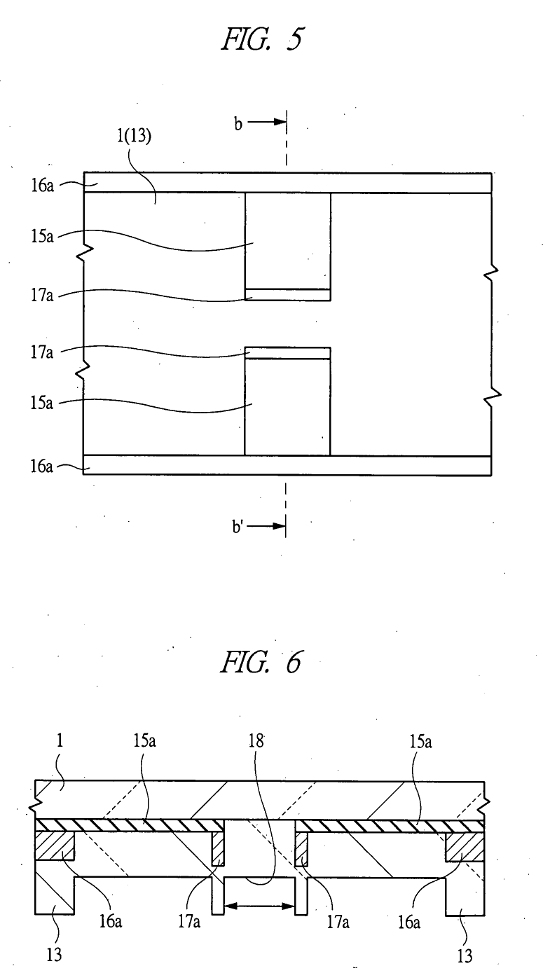

Note that, in the example shown in FIG. 3 and FIG. 4, the present invention is applied to the ALIS (Alternate Lighting of Surfaces) method which is the drive method for achieving high definition and high luminance by performing the display alternately in the odd-numbered lines and the even-numbered lines corresponding to the X electrodes 11 and the Y electrodes 12 of the plasma display panel. However, the present invention can also be applied to the following example shown in FIG. 5 and FIG. 6. FIG. 5 is a plan view showing another example of a planar structure of the principal part of the front plate and FIG. 6 is a cross-sectional view showing another example of a cross-sectional structure of the principal part of the front plate (section taken along the line b-b′ in FIG. 5), respectively.

In the example of FIG. 5 and FIG. 6, a bus electrode 16a is provided at one end of a transparent electrode 15a and a separation bus 17a is provided at the other end of the transparent electrode 15a, but the rest is the same as that shown in FIG. 3 and FIG. 4. Also in this structure, the dielectric layer 13 in the part of the X electrode 11 and the Y electrode 12 of the front plate 1 has a surface shape reflecting the unevenness resulting from the thickness of the bus electrode 16a and the separation bus 17a on the front plate 1. In particular, a recessed portion 18 resulting from the thickness of the separation bus 17a can be formed in the gap portion.

Therefore, according to the present embodiment, in a plasma display panel comprising: an electrode group of the x electrodes 11 and the Y electrodes 12 constituted of the transparent electrodes 15 and 15a disposed in parallel to each other on the front plate 1 and adjacently arranged at predetermined intervals while forming spaces for discharge therebetween and the bus electrodes 16 and 16a which are thicker than the transparent electrodes 15 and 15a, have lower electric resistance and are electrically connected to the transparent electrodes 15 and 15a; the dielectric layer 13 and the protective layer 14 which cover the electrode group of the X electrodes 11 and the Y electrodes 12; and an electrode group of the address electrodes 21 disposed on the rear plate 2 opposed to the front plate 1 and arranged in a direction almost perpendicular to that of the electrode group of the X electrodes 11 and the Y electrodes 12, the bus electrodes 16 and 16a continuously extending from one end of the front plate 1 to near the other end are disposed at the position away from the discharging edge of the transparent electrodes 15 and 15a, and the separation buses 17 and 17a thicker than the transparent electrodes 15 and 15a are provided at the discharging edge of the transparent electrodes 15 and 15a. By this means, the dielectric layer 13 on the front plate 1 can be formed to have a surface shape reflecting the unevenness resulting from the thickness of the bus electrodes 16 and 16a and the separation buses 17 and 17a on the front plate 1.

More specifically, the novel separation buses 17 and 17a are provided at the discharging edge of the transparent electrodes 15 and 15a, and the dielectric layer 13 is formed on the separation buses 17 and 17a by the vapor deposition method. By this means, since the recessed portion 18 resulting from the thickness of the separation buses 17 and 17a can be formed in the gap portion, the discharge can be started by the opposed discharge between the right and left sides of the recessed portion 18 in FIG. 4 (shown by arrow) instead of the surface discharge, and the firing voltage can be reduced. As a result, it becomes possible to further reduce the surface discharge voltage and to contribute to the reduction of the address discharge delay.

Further, since the novel separation buses 17 and 17a can be formed through the same process as that of the previously-provided bus electrodes 16 and 16a, it is unnecessary to additionally provide new process. Accordingly, since the new process is not additionally provided, the plasma display panel can be manufactured without any cost increase.

In the foregoing, the invention made by the inventors of the present invention has been concretely described based on the embodiments. However, it is needless to say that the present invention is not limited to the foregoing embodiments and various modifications and alterations can be made within the scope of the present invention.

### INDUSTRIAL APPLICABILITY

The present invention relates to a plasma display apparatus. In particular, it can be effectively applied to a structure of a front plate of a plasma display panel provided in the plasma display apparatus.

1. A plasma display panel, comprising:
a first substrate in which a first electrode group including a plurality of optically-transparent electrodes and a plurality of metal electrodes having lower electric resistance than the optically-transparent electrode and electrically connected to the optically-transparent electrode, a dielectric layer covering the first electrode group, and a protective layer covering the dielectric layer are disposed and discharging spaces are formed between the adjacent optically-transparent electrodes; and
a second substrate arranged so as to be opposed to the first substrate and having a second electrode group disposed in a direction almost perpendicular to the first electrode group,
wherein a conductive layer is formed adjacent to the discharging space on the optically-transparent electrode, and the dielectric layer of the first substrate has a surface shape reflecting unevenness resulting from a thickness of the first electrode group and the conductive layer.

2. The plasma display panel according to claim 1,
wherein the conductive layer has a width smaller than the metal electrode.

3. The plasma display panel according to claim 1,
wherein the conductive layer has a thickness of 2 μm or more and is formed to be thinner than the dielectric layer.

4. The plasma display panel according to claim 1,
wherein the conductive layer is made of the same material as that of the metal electrode and is formed to have the same height as that of the metal electrode.

5. The plasma display panel according to claim 1,
wherein the dielectric layer has a thickness of 10 μm or less and is formed to be thicker than the conductive layer.

6. The plasma display panel according to claim 1,
wherein the dielectric layer is formed by a vapor deposition method.

7. The plasma display panel according to claim 1,
wherein the optically-transparent electrode has a shape corresponding to a cell, and the conductive layer is formed to be separated for each cell.

8. A plasma display apparatus having a plasma display panel and a drive circuit for applying voltage to electrodes of the plasma display panel,
wherein the plasma display panel comprises: a first substrate in which a first electrode group including a plurality of optically-transparent electrodes and a plurality of metal electrodes having lower electric resistance than the optically-transparent electrode and electrically connected to the optically-transparent electrode, a dielectric layer covering the first electrode group, and a protective layer covering the dielectric layer are disposed and discharging spaces are formed between the adjacent optically-transparent electrodes; and
a second substrate arranged so as to be opposed to the first substrate and having a second electrode group disposed in a direction almost perpendicular to the first electrode group, and
a conductive layer is formed adjacent to the discharging space on the optically-transparent electrode, and the dielectric layer of the first substrate has a surface shape reflecting unevenness resulting from a thickness of the first electrode group and the conductive layer.

9. The plasma display apparatus according to claim 8,
wherein the conductive layer has a width smaller than the metal electrode.

10. The plasma display apparatus according to claim 8,
wherein the conductive layer has a thickness of 2 μm or more and is formed to be thinner than the dielectric layer.

11. The plasma display apparatus according to claim 8,
wherein the conductive layer is made of the same material as that of the metal electrode and is formed to have the same height as that of the metal electrode.

12. The plasma display apparatus according to claim 8,
wherein the dielectric layer has a thickness of 10 μm or less and is formed to be thicker than the conductive layer.

13. The plasma display apparatus according to claim 8,
wherein the dielectric layer is formed by a vapor deposition method.

14. The plasma display apparatus according to claim 8,
wherein the optically-transparent electrode has a shape corresponding to a cell, and the conductive layer is formed to be separated for each cell.
